(19) United States
(12) Patent Application Publication
(10) Pub. No.: US 2026/0304303 A1
(43) Pub. Date: Oct. 1, 2026

(54) SIGNAL LEVEL ENHANCED NETWORK SELECTION

(71) Applicant: APPLE INC., Cupertino, CA (US)

(72) Inventors: Vivek G Gupta, San Jose, CA (US); Stanley M Mayalil, San Jose, CA (US); Sridhar Prakasam, Fremont, CA (US); Anikethan Ramakrishna Vijaya Kumar, Bengaluru (IN); Nirlesh Koshta, Bengaluru (IN)

(21) Appl. No.: 19/100,657

(22) PCT Filed: Aug. 9, 2023
(86) PCT No.: PCT/US2023/071927

§ 371 Date: Feb. 3, 2025

(30) Foreign Application Priority Data
Aug. 10, 2022 (IN) 202211045610

(51) Int. Cl. H04W 48/18; H04W 48/16; H04W 60/00; H04W 84/04

(52) U.S. Cl. CPC H04W 48/18; H04W 48/16; H04W 60/00; H04W 84/042

(57) ABSTRACT

Embodiments herein include methods, systems, and apparatuses for performing an automatic network selection based on an operator controlled signal threshold. A signal threshold file may be available on a Universal Subscriber Identity Module (USIM). The signal threshold file may include one or more operator controlled signal threshold. A user equipment (UE) may perform a signal threshold based public land mobile network (PLMN) selection procedure using the operator controlled signal threshold.

### CROSS-REFERENCE TO RELATED APPLICATION(S)

This application claims priority to India patent application No. 202211045610, filed Aug. 10, 2022, which is hereby incorporated by reference herein in its entirety.

### TECHNICAL FIELD

This application relates generally to wireless communication systems, including an automatic public land mobile network search procedure based on an operator controlled signal threshold.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a flow chart of method for a stationary IoT UE performing automatic PLMN selection during power on or recovery in accordance with some embodiments.

FIG. 2 illustrates a flow chart of method for a stationary IoT UE performing automatic PLMN selection during a periodic scan when on a RPLMN in accordance with some embodiments.

FIG. 3 illustrates an elementary file that indicates an access technology and an associated operator controlled signal in accordance with some embodiments.

FIG. 4 illustrates an elementary file that indicates a location, an access technology, and an associated operator controlled signal in accordance with some embodiments.

FIG. 5 illustrates an example architecture of a wireless communication system, according to embodiments disclosed herein.

FIG. 6 illustrates a system for performing signaling between a wireless device and a network device, according to embodiments disclosed herein.

### DETAILED DESCRIPTION

Various embodiments are described with regard to a User Equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Internet of Things (IoT) devices (also referred to herein as IoT UEs) include hardware configured for certain applications that are capable of transmitting data over a network. For example, IoT devices may include sensors or actuators to monitor environmental conditions. Use cases for stationary IoT devices are growing exponentially. For instance, stationary IoT devices may be used in water meters, to monitor power grids, or for temperature measurements.

Sometimes when deployed outdoors these devices cannot be reached easily. For instance, IoT devices may be placed in remote locations. Additionally, sometimes the local coverage conditions in the deployed location can be very challenging. Stationary IoT UEs do not move and are often in a permanent roaming situation. The permanent roaming situation may be caused by IoT UEs being deployed in countries different than that of the provided Universal Subscriber Identity Module (USIM) or because of the use of Global USIMs for IoT use cases.

Since the IoT UEs are stationary, the IoT UEs stay constantly in nearly the same coverage condition. Some of these IoT UEs experience unstable conditions, and since they do not move, these IoT UEs consistently experience these unstable conditions. One of the sources of the unstable condition is the selection procedure.

During the network selection procedure (e.g., public land mobile network (PLMN) selection) sometimes the IoT UE selects a visited PLMN (VPLMN) where the IoT UE can barely attach and stays on that VPLMN. Due to changing radio conditions (e.g. fading, absorption, etc.) setting up a data bearer occasionally or nearly always fails. For example, an IoT UE may be programed to attempt to send a temperature measurement out every hour. However, the IoT UE may fail to transmit the data due to the poor connection with the selected VPLMN.

It may be difficult for the operators of the PLMNs to detect such problems. During initial installation of the IoT UE it may appear that the connection successfully is established. Further, once such cases occur manual intervention on site is needed to identify and fix the problem. The manual intervention would impact operating expenses and deployments because these IoT UEs are often in remote difficult to reach locations. Therefore, even if these problems are detected they are often ignored and the problem persists.

One of the main reasons that the IoT UE selects a VPLMN element with poor coverage is due to current network selection procedures which impacts how VPLMNs are selected. During the initial steps of selecting a network after switch on or recovery, the signal level of available cells is not taken into account. Instead, the IoT UE solely considers the cell selection criteria as broadcast by the PLMN and the priority of networks. This may affect the IoT UE not only during initial selection, but also during recovery from a loss of coverage and during the steps of periodic re-selection. Thus, the IoT UE may select a PLMN based on priority rather than signal level.

As such the IoT UE selects or stays on a network with poor coverage at that particular location, because the selected PLMN has higher priority than other PLMNs. Under current network selection procedures, the IoT UE will select a PLMN based on priority even if the selected PLMN has worse coverage than other available PLMNs with lower priority that have much better local coverage.

For typical consumer UEs (e.g., cell phone) this is not typically a problem because a mobility of the typical consumer UE causes the conditions to change quickly and there is a user present who can recognizes the problems and can react. For example the user may change the location of the UE, or the user may apply manual PLMN selection. This selection behavior may be desirable as part of steering of roaming and avoiding frequent changes of networks. However, for stationary devices without supervision by a user the network selection behavior may be a big problem.

Some embodiments herein provide an improvement to the network selection procedure by allowing the IoT UE to take the signal level of available cells into account. Embodiments herein include methods to take the signal level into account during the initial steps of network selection after switch-on, during recovery from loss of coverage, and during steps of the periodic re-selection.

Embodiments herein include stationary IoT UEs supporting any, or a combination, of narrowband (NB)-IoT, Global System for Mobile Communication (GSM) Enhanced Data for GSM Evolution (EDGE) Radio Access Network (GERAN) extended coverage (EC)-GSM-IoT, and Category M1 or M2 of Evolved Universal Terrestrial Radio Access (E-UTRA). Embodiments herein may include a 5G system that supports a mechanism to enable the home operator to configure, update, or delete an operator controlled signal threshold per access technology on the USIM. The automatic network selection procedures may be enhanced in cases where the “Operator controlled signal threshold per access technology” is configured on the USIM. The allowed range of the Operator controlled signal threshold per access technology may be between the cell selection criterion and the high quality signal as defined in technical specifications (TS) (e.g., TS 23.122).

Embodiments herein consider various aspects of signal level enhanced network selection. For instance, aspects of the embodiments include how the operator controlled signal threshold per access technology is configured. Additionally, aspects of the embodiments consider the allowed range of the operator controlled signal threshold per access technology. Further, some embodiments consider specific impacts on the USIM. Some embodiments consider enhancements to the Non-access stratum (NAS) automatic network selection procedure. Some embodiments consider enhancements to the NAS periodic network selection procedure. Some embodiments consider the impact of the cell selection criteria.

3GGP TS 23.122 defines various aspects of the automatic network selection procedure. The automatic network selection procedure occurs after power on, recovery from lack of coverage, on user request, periodically in the background. Every network broadcasts cell selection criteria (e.g., signal level and quality criteria). Only cells meeting these criteria are taken into consideration for further steps.

Further, cells are marked high quality with better signal level than: 85 decibel milliwatts (dBm) for GSM; 95 dBm for UTRAN Frequency Division Duplexing (FDD); 84 dBm for UTRAN Time Division Duplexing (TDD); and 110 dBm for LTE, NB-IoT and NR. List of cells either marked as high quality or with signal level are provided to NAS (in the UE) for network selection. However, these high quality designations are not usually considered in the automatic network procedure.

Usually, the IoT UE looks for the last registered PLMN (RPLMN) and selects this. As a home PLMN (HPLMN) controlled option the IoT UE might try to find an equivalent (E) HPLMN first. If those PLMN are not available, the IoT UE then runs through various lists in priority order. Currently, only if there is no RPLMN or higher in priority PLMN does the IoT UE select a network based on the high-quality indication/signal level. All previous steps rely on the cell selection criteria only.

3GPP TS 23.122 includes the following steps for automatic network selection:

### 4.4.3.1.1 Automatic Network Selection Mode Procedure

The mobile station (MS) selects and attempts registration on other PLMN/access technology combinations, if available and, for bullets i, ii, iii, iv, v, allowable, in the following order:
i) either the HPLMN (if the EHPLMN list is not present or is empty) or the highest priority EHPLMN that is available (if the EHPLMN list is present);
ii) each PLMN/access technology combination in the “User Controlled PLMN Selector with Access Technology” data file in the SIM (in priority order);
iii) each PLMN/access technology combination in the “Operator Controlled PLMN Selector with Access Technology” data file in the SIM (in priority order) or stored in the ME (in priority order);
iv) other PLMN/access technology combinations with received high quality signal in random order;

NOTE 1: High quality signal is defined in the appropriate AS specification.
v) other PLMN/access technology combinations in order of decreasing signal quality.

As can be seen in steps 1-3 the PLMN is selected with no regard to signal quality. It is not until steps four and five that signal quality is taken into account. A stationary IoT UE often does not make it to steps four and five, because it is often the case that the IoT UE can find a PLMN that meets the requirements of steps 1-3. Embodiments herein address this lake of consideration of signal quality for automatic network selection procedures.

Embodiments herein allow an operator to configure a signal threshold. The signal threshold is a value separate from the high quality values and may be configured per access technology. The threshold may be configured for NB-IoT, GERAN EC-GSM-IoT and Category M1 or M2 of E-UTRA. The threshold may be pre-provisioned in the USIM in a data file, or in the mobile equipment (ME). The threshold may be updated using NAS steering of roaming (SoR) procedure. The operator controlled signal threshold is delivered to UE using NAS signaling (using SoR procedure) as part of REGISTRATION ACCEPT or DL NAS TRANSPORT messages in SOR transparent container information element (IE). The threshold may be updated using SIM Toolkit which can trigger SIM Refresh command to change contents of SIM elementary files (EF).

In some embodiments, the allowed range of the operator controlled signal threshold per access technology is between cell selection criterion and high quality signal level. The high quality signal level may be set as defined in 3GPP TS 23.122. For example, the high quality signal level may be a cell with better signal level than: 85 dBm for GSM; 95 dBm for UTRAN FDD; 84 dBm for UTRAN TDD; and 110 dBm for LTE, NB-IoT and NR. In other words, the signal threshold of embodiments herein may be set so as not to exceed the high quality signal level for the access technology. The signal threshold allows the operator to specify a lower range of acceptable signal level.

In some embodiments, the signal threshold may be area specific. For example, the signal threshold may be specific to a geographical area and a PLMN. For instance, a signal threshold may be set for parts of Asia and a different signal threshold may be set for parts of Europe.

The IoT UEs may be provided with three items in a data file, a location identifier, an access technology, and the signal threshold. The signal threshold value may vary per location identifier and access technology. The location identifier may include a PLMN identity and a tracking area code. The access technology may include one or more of NB-IoT, GERAN EC-GSM-IoT and Category M1 or M2 of E-UTRA. The signal threshold may be set by the operator to a value that does not exceed the high quality signal level established in a standard.

Some embodiments herein use the signal threshold value to enhance an automatic network selection procedure. For instance, the automatic PLMN search procedure (e.g., the procedure found in 3GPP TS 23.122 section 4.4.3.1.1) may be updated as follows. In some embodiments, if the operator controlled signal threshold per access technology data file is available on the USIM, the MS shall select the network only if the network selection conditions are met and the received signal quality of the candidate PLMN/access technology combination is equal to or higher than the signal strength in operator controlled signal threshold per access technology data file. If no candidate PLMN/access technology combination fulfills the Operator controlled signal threshold criteria, the UE shall repeat the automatic network selection procedure without applying the operator controlled signal threshold per access technology. Thus, the UE may compare a received signal quality of a candidate PLMN to the operator controlled signal threshold to determine a suitable PLMN candidate and if a suitable candidate is not found, the UE may perform an automatic network selection procedure without considering the operator controlled signal threshold.

Further, in some embodiments the periodic network selection procedure may be updated in a similar way as the automatic PLMN search procedure. Further, if the registration fails for some reason on a newly selected PLMN, the UE may revert back to legacy PLMN selection procedure. That is the UE may repeat the automatic network selection procedure without applying the operator controlled signal threshold per access technology.

The enhanced automatic network selection procedure may be applicable only for stationary UEs. It may not be desirable to impact a consumer cellular device that may move at any moment to an area with better coverage. Therefore, embodiments herein specifically address stationary UEs. The UE may apply the enhanced automatic network selection procedure only at specific locations identified by an operator. If the UE moves to another location, then the UE may not need to follow the threshold set in USIM as it may no longer be applicable, or the entire procedure may have to be evaluated and applied again.

In some embodiments, the cell selection criteria may be updated based on the signal threshold. For example, the criteria may be updated when the operator controlled signal threshold per access technology data file is available on the USIM, the MS shall select the network only if the signal quality of the candidate access technology is equal to or higher than the signal strength in operator controlled signal threshold per access technology data file. Further, in some embodiments criteria should be applied only to specific cell or tracking area instead of entire PLMN for the specific access technology.

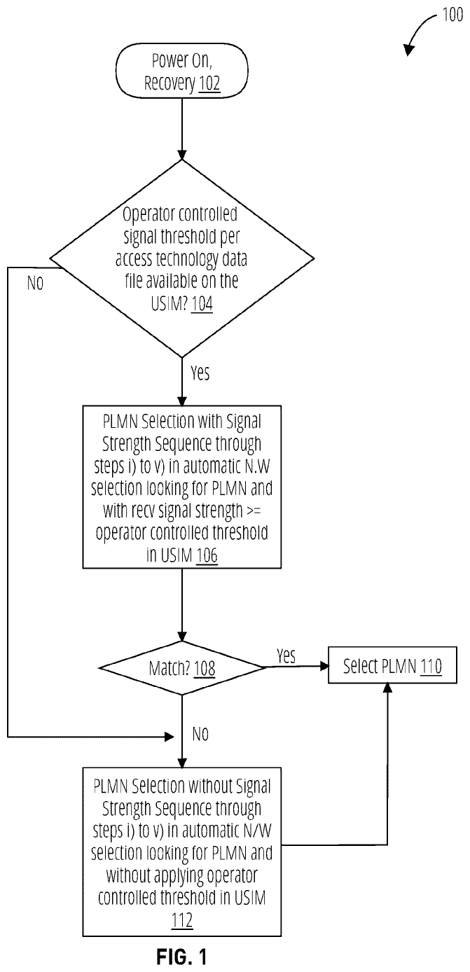

FIG. 1 illustrates a flow chart of method 100 for a stationary IoT UE performing automatic PLMN selection during power on or recovery. As shown, the IoT UE initiates this method 100 during a power on or recovery event 102. The method 100 is an updated PLMN selection procedure with operator controlled signal threshold per access technology data file available on the USIM.

The IoT UE determines 104 if an operator controlled signal threshold per access technology data file is available on the USIM. The threshold may be configured for NB-IoT, GERAN EC-GSM-IoT and Category M1 or M2 of E-UTRA. The threshold may be pre-provisioned in the USIM in a data file, or in the ME. The threshold may be updated using NAS SoR procedure. The operator controlled signal threshold is delivered to UE using NAS signaling (using SoR procedure) as part of REGISTRATION ACCEPT or DL NAS TRANSPORT messages in SOR transparent container IE. The threshold may be updated using SIM Toolkit which can trigger SIM Refresh command to change contents of SIM EF. The signal threshold sets a minimum value for a PLMN. In some embodiments, the IoT UE may additionally determine if a current location matches a location associated with the signal threshold.

If the IoT UE determines 104 that there is a signal threshold available, the IoT UE performs 106 PLMN selection with signal strength sequence (signal threshold based PLMN selection procedure). The PLMN selection with signal strength sequence is based on the operator controlled signal threshold. The signal strength sequence considers if a received signal strength of a candidate PLMN is greater than or equal to the operator controlled signal threshold in the USIM.

For example, the IoT UE may determine available PLMN using the following steps. The IoT UE may progress through the steps until a match is found or all the steps have been completed. In a first step, the IoT UE may attempt to determine a PLMN that is either the HPLMN (if the EHPLMN list is not present or is empty) or the highest priority EHPLMN that is available (if the EHPLMN list is present). The PLMN identified in the first step must have a received signal quality that is equal to or higher than the signal strength in the operator controlled signal threshold.

If no PLMNs meet the condition in the first step, the IoT UE may progress to a second step. In the second step, the IoT UE may attempt to determine each PLMN/access technology combination in the “User Controlled PLMN Selector with Access Technology” data file in the SIM (in priority order). As in the first step, any PLMN identified in the second step must have a received signal quality that is equal to or higher than the signal strength in the operator controlled signal threshold.

If no PLMNs meet the condition in the second step, the IoT UE may progress to a third step. In the third step, the IoT UE may attempt to determine each PLMN/access technology combination in the “Operator Controlled PLMN Selector with Access Technology” data file in the SIM (in priority order) or stored in the ME (in priority order). As in the previous steps, any PLMN identified in the second step must have a received signal quality that is equal to or higher than the signal strength in the operator controlled signal threshold.

If no PLMNs meet the condition in the third step, the IoT UE may progress to a fourth step. In the fourth step, the IoT UE may attempt to determine other PLMN/access technology combinations with received high quality signal in random order. The high quality signal will be greater than or equal to the operator controlled signal threshold.

If no PLMNs meet the condition in the fourth step, the IoT UE may progress to a fifth step. In the fifth step, the IoT UE may attempt to determine other PLMN/access technology combinations in order of decreasing signal quality. Any PLMN identified in the fifth step must have a received signal quality that is equal to or higher than the signal strength in the operator controlled signal threshold.

The IoT UE determines 108 if there is a PLMN that matches the conditions in the PLMN selection with the signal strength sequence. If there is a match, the IoT UE may select 110 the PLMN matching the conditions. The IoT UE selects and attempts registration on PLMN that match the conditions and meet or exceed the operator controlled signal threshold in the order of the steps outlined above for the PLMN selection with signal strength sequence.

If the IoT UE determines 104 that there is not an operator controlled signal threshold, the operator controlled signal threshold is not applicable for a current location, or if the PLMN selection with signal strength sequence does not determine 108 a PLMN match, the IoT UE may perform 112 a PLMN selection without signal strength sequence (non-signal threshold based PLMN selection procedure). For example, the IoT UE may perform steps i) to v) in automatic network selection looking for PLMN without applying operator controlled threshold in USIM, where steps i) to v) include: that the IoT UE selects and attempts registration on other PLMN/access technology combinations, if available and, for bullets i, ii, iii, iv, v, allowable, in the following order:
i) either the HPLMN (if the EHPLMN list is not present or is empty) or the highest priority EHPLMN that is available (if the EHPLMN list is present);
ii) each PLMN/access technology combination in the “User Controlled PLMN Selector with Access Technology” data file in the SIM (in priority order);
iii) each PLMN/access technology combination in the “Operator Controlled PLMN Selector with Access Technology” data file in the SIM (in priority order) or stored in the ME (in priority order);
iv) other PLMN/access technology combinations with received high quality signal in random order;
NOTE 1: High quality signal is defined in the appropriate AS specification.
v) other PLMN/access technology combinations in order of decreasing signal quality.

The IoT UE may then select 110 the PLMN identified by the PLMN selection without signal strength selection sequence.

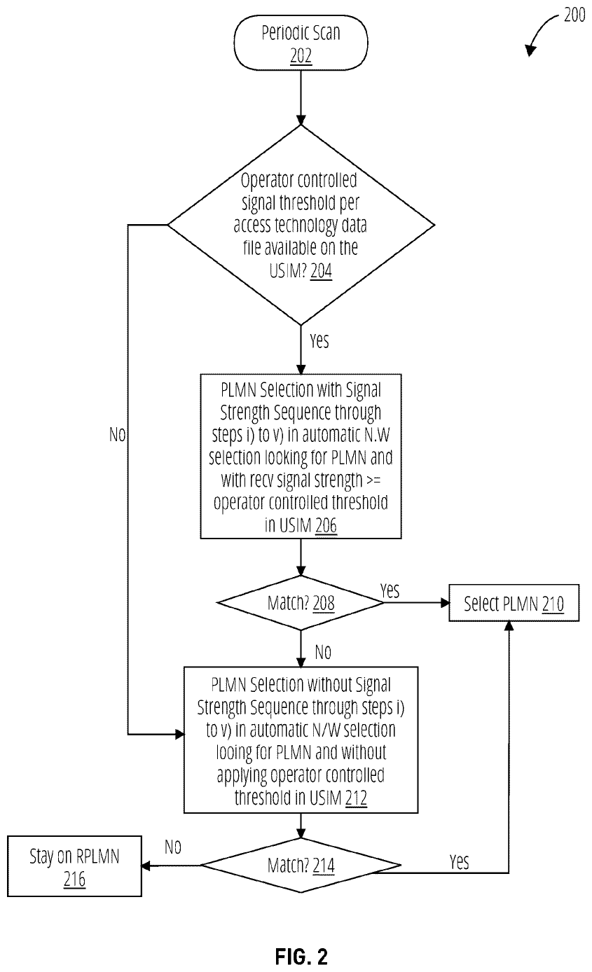

FIG. 2 illustrates a flow chart of method 200 for a stationary IoT UE performing automatic PLMN selection during a periodic scan when on a RPLMN. As shown, the IoT UE initiates this method 200 during a periodic scan 202. The method 200 is an updated PLMN selection procedure with operator controlled signal threshold per access technology data file available on the USIM.

The IoT UE determines 204 if an operator controlled signal threshold per access technology data file is available on the USIM. The threshold may be configured for NB-IoT, GERAN EC-GSM-IoT and Category M1 or M2 of E-UTRA. The threshold may be pre-provisioned in the USIM in a data file, or in the ME. The threshold may be updated using NAS SoR procedure. The operator controlled signal threshold is delivered to UE using NAS signaling (using SoR procedure) as part of REGISTRATION ACCEPT or DL NAS TRANSPORT messages in SOR transparent container IE. The threshold may be updated using SIM Toolkit which can trigger SIM Refresh command to change contents of SIM EF. The signal threshold sets a minimum value for a PLMN. In some embodiments, the IoT UE may additionally determine if a current location matches a location associated with the signal threshold.

If the IoT UE determines 204 that there is a signal threshold available, the IoT UE performs 206 PLMN selection with signal strength sequence (signal threshold based PLMN selection procedure). The PLMN selection with signal strength sequence is based on the operator controlled signal threshold. The signal strength sequence considers if a received signal strength of a candidate PLMN is greater than or equal to the operator controlled signal threshold in the USIM.

For example, the IoT UE may determine available PLMN using the following steps. The IoT UE may progress through the steps until a match is found or all the steps have been completed. In a first step, the IoT UE may attempt to determine a PLMN that is either the HPLMN (if the EHPLMN list is not present or is empty) or the highest priority EHPLMN that is available (if the EHPLMN list is present). The PLMN identified in the first step must have a received signal quality that is equal to or higher than the signal strength in the operator controlled signal threshold.

If no PLMNs meet the condition in the first step, the IoT UE may progress to a second step. In the second step, the IoT UE may attempt to determine each PLMN/access technology combination in the “User Controlled PLMN Selector with Access Technology” data file in the SIM (in priority order). As in the first step, any PLMN identified in the second step must have a received signal quality that is equal to or higher than the signal strength in the operator controlled signal threshold.

If no PLMNs meet the condition in the second step, the IoT UE may progress to a third step. In the third step, the IoT UE may attempt to determine each PLMN/access technology combination in the “Operator Controlled PLMN Selector with Access Technology” data file in the SIM (in priority order) or stored in the ME (in priority order). As in the previous steps, any PLMN identified in the second step must have a received signal quality that is equal to or higher than the signal strength in the operator controlled signal threshold.

If no PLMNs meet the condition in the third step, the IoT UE may progress to a fourth step. In the fourth step, the IoT UE may attempt to determine other PLMN/access technology combinations with received high quality signal in random order. The high quality signal will be greater than or equal to the operator controlled signal threshold.

If no PLMNs meet the condition in the fourth step, the IoT UE may progress to a fifth step. In the fifth step, the IoT UE may attempt to determine other PLMN/access technology combinations in order of decreasing signal quality. Any PLMN identified in the fifth step must have a received signal quality that is equal to or higher than the signal strength in the operator controlled signal threshold.

The IoT UE determines 208 if there is a PLMN that matches the conditions in the PLMN selection with signal strength sequence. If there is a match, the IoT UE may select 210 the PLMN matching the conditions. The IoT UE selects and attempts registration on PLMN that match the conditions and meet or exceed the operator controlled signal threshold in the order of the steps outlined above for the PLMN selection with signal strength sequence.

If the IoT UE determines 204 that there is not an operator controlled signal threshold, the operator controlled signal threshold is not applicable for a current location, or if the PLMN selection with signal strength sequence does not determine 208 a PLMN match, the IoT UE may perform 212 a PLMN selection without signal strength sequence (non-signal threshold based PLMN selection procedure). For example, the IoT UE may perform steps i) to v) in automatic network selection looking for PLMN without applying operator controlled threshold in USIM, where steps i) to v) include: that the IoT UE selects and attempts registration on other PLMN/access technology combinations, if available and, for bullets i, ii, iii, iv, v, allowable, in the following order:
i) either the HPLMN (if the EHPLMN list is not present or is empty) or the highest priority EHPLMN that is available (if the EHPLMN list is present);
ii) each PLMN/access technology combination in the “User Controlled PLMN Selector with Access Technology” data file in the SIM (in priority order);
iii) each PLMN/access technology combination in the “Operator Controlled PLMN Selector with Access Technology” data file in the SIM (in priority order) or stored in the ME (in priority order);
iv) other PLMN/access technology combinations with received high quality signal in random order;
NOTE 1: High quality signal is defined in the appropriate AS specification.
v) other PLMN/access technology combinations in order of decreasing signal quality.

The IoT UE may then select 210 the PLMN identified by the PLMN selection without signal strength selection sequence if a match is determined 214 that is better than the RPLMN. Otherwise, the IoT UE may stay 216 on the RPLMN.

Method 100 and method 200 may be implemented as follows in an Automatic Network Selection Mode Procedure section of a standard (e.g., an updated TS 23.122 section 4.4.3.1.1). The MS selects and attempts registration on other PLMN/access technology combinations, if available and, for bullets i, ii, iii, iv, v, allowable, in the following order:
i) either the HPLMN (if the EHPLMN list is not present or is empty) or the highest priority EHPLMN that is available (if the EHPLMN list is present);
ii) each PLMN/access technology combination in the “User Controlled PLMN Selector with Access Technology” data file in the SIM (in priority order);
iii) each PLMN/access technology combination in the “Operator Controlled PLMN Selector with Access Technology” data file in the SIM (in priority order) or stored in the ME (in priority order);
iv) other PLMN/access technology combinations with received high quality signal in random order;
NOTE 1: High quality signal is defined in the appropriate AS specification.
v) other PLMN/access technology combinations in order of decreasing signal quality.

When following the above procedure the following requirements apply: If the operator controlled signal threshold per access technology data file is available on the USIM, the MS shall select the network only if the network selection conditions are met and the received signal quality of the candidate PLMN/access technology combination is equal to or higher than the signal strength in operator controlled signal threshold per access technology data file. If no candidate PLMN/access technology combination fulfills the Operator controlled signal threshold criteria, the UE shall repeat the automatic network selection procedure without applying the operator controlled signal threshold per access technology.

Additionally, the cell selection criterion may be modified to include the operator configured cell signal threshold for access technology. For example, as part of the cell selection criterion, the IoT UE may determine if the measured cell RX level value (RSRP) is greater than or equal to the operator configured cell signal threshold for access technology.

In some embodiments, the UE shall use one of the following two cell selection procedures: a) Initial Cell Selection; and b) Stored Information Cell Selection. During initial cell selection, this procedure requires no prior knowledge of which RF channels are E-UTRA or NB-IoT carriers. The UE shall scan all RF channels in the E-UTRA bands according to its capabilities to find a suitable cell. On each carrier frequency, the UE need only search for the strongest cell. Once a suitable cell is found this cell shall be selected. During Stored Information Cell Selection, this procedure requires stored information of carrier frequencies and optionally also information on cell parameters, from previously received measurement control information elements or from previously detected cells. Once the UE has found a suitable cell the UE shall select it. If no suitable cell is found the Initial Cell Selection procedure shall be started.

In some embodiments, if the measurements are performed using RSS as specified in 3GPP TS 36.133, the cell selection criterion S in normal coverage is fulfilled when: Srxlev>0. Else, the cell selection criterion S in normal coverage is fulfilled when: Srxlev>0 AND Squal>0. If operator controlled signal threshold per access technology data file is available on the USIM the cell selection criterion S in normal coverage is fulfilled when:

$$Srxlev > 0 AND Squal > 0 AND Qrxlevrneas >= QUSIM .$$

where: Srxlev=Qrxlevmeas−(Qrxlevmin+Qrxlevminoffset)−Pcompensation−Qoffsettemp

$$Sequal = Qqualmeas - ( Qqualmin + Qqualminoffset ) - Qoffsettemp$$

Qrxlevemeas: Measured cell RX level value (RSRP)
QUSIM: Operator configured cell RX signal threshold for access technology, and where Table 1 provides additional parameters.

TABLE 1

| | |
|---|---|
| Srxlev | Cell selection RX level value (dB) |
| Squal | Cell selection quality value (dB) |
| Qoffsetₜₑₘₚ | Offset temporarily applied to a cell as |
| | specified in TS 36.331 (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum |
| required | |
| RX level in the cell (dBm). Qᵣₓₗₑᵥₘᵢₙ is | |
| obtained from q-RxLevMin in SIB1, | |
| SIB3, SIB5, or NR SIB5. | |
| When the UE who is camped on a NR | |
| cell is evaluating an E-UTRA cell, if | |
| Q_{rxlevminoffsetcell} is signaled in NR SIB5 in | |
| TS 38.331 for the E-UTRA cell, this cell | |
| specific offset is added to q-RxLevMin | |
| to achieve the | |
| required | |
| minimum RX level in the E-UTRA cell. | |
| Q_{qualmin} | Minimum |
| required | |
| quality level in the cell (dB) | |
| When the UE who is camped on a NR | |
| cell is evaluating an E-UTRA cell, if | |
| Q_{qualminoffsetcell} is signaled in NR SIB5 in | |
| TS 38.331 for the E-UTRA cell, this cell | |
| specific offset is added to achieve the | |
| required | |
| minimum quality level in the E-UTRA | |
| cell. | |
| Q_{rxlevminoffset} | Offset to the signaled Qᵣₓₗₑᵥₘᵢₙ taken into |
| | account in the Srxlev evaluation as a |
| | result of a periodic search for a higher |
| | priority PLMN while camped normally |
| | in a VPLMN TS 23.122 |
| Q_{qualminoffset} | Offset to the signaled Q_{qualmin} taken into |
| | account in the Squal evaluation as a |
| | result of a periodic search for a higher |
| | priority PLMN while camped normally |
| | in a VPLMN TS 23.122 |
| Pcompensation | If the UE supports the additionalPmax |
| | in the NS-PmaxList, if present, in SIB1, |
| | SIB3 and SIB5: |
| | max(P_{EMAX1} − P_{PowerClass}, 0) − |
| | (min(P_{EMAX2}, P_{PowerClass}) − min(P_{EMAX1}, |
| | P_{PowerClass})) (dB); |
| | else: |
| | if P_{PowerClass} is 14 dBm: |
| | max(P_{EMAX1} − (P_{PowerClass} − Poffset), 0) |
| | (dB); |
| | else: |
| | max(P_{EMAX1} − P_{PowerClass}, 0) (dB) |
| | For IAB-MT, P_{compensation} is set to 0. |
| P_{EMAX1}, P_{EMAX2} | Maximum TX power level an UE may |
| | use when transmitting on the uplink in |
| | the cell (dBm) defined as P_{EMAX} in TS |
| | 36.101 [33]. P_{EMAX1} and P_{EMAX2} are |
| | obtained from the p-Max and the NS- |
| | PmaxList respectively in SIB1, SIB3 and |
| | SIB5 as specified in TS 36.331. |
| P_{PowerClass} | Maximum RF output power of the UE |
| | (dBm) according to the UE power class |
| | as defined in TS 36.101 |

Similarly, the cell selection criterion for NB-IoT may be modified to include the operator configured cell signal threshold for access technology. In some embodiments, if the measurements are performed on the non-anchor carrier and UE meets the requirements specified in TS 36.133 the cell selection criterion S is fulfilled when: Srxlev>0. Else, the cell selection criterion S is fulfilled when: Srxlev>0 AND Squal>0. If operator controlled signal threshold per access technology data file is available on the USIM the cell selection criterion S in normal coverage is fulfilled when:

$$Srxlev > 0 AND Squal > 0 AND Qrxlevrneas >= QUSIM .$$

Where:

$$Srxlev = {Q}_{rxlevmeas} - ( {Q}_{rxlevmin} + {Q}_{rxlevminoffset} ) - Pcompensation - {Qoffset}_{temp}$$

$$Squal = {Q}_{qualmeas} - ( {Q}_{qualmin} + {Q}_{qualminoffset} ) - {Qoffset}_{temp}$$

Additionally, the USIM may be updated to include information regarding the operator controlled signal threshold per access technology. For example, in some embodiments, the USIM may include an Access technology identifier and a corresponding signal strength threshold. In some embodiments, the USIM may also include the location (e.g., location area identity, tracking area) where the corresponding signal strength threshold may be applicable. Further, the elementary file (EF) for the USIM service table (EFᵤₛₜ) may be updated. The EFᵤₛₜ indicates which services are available. If a service is not indicated as available in the USIM, the ME shall not select this service. One service that may be included in the EFᵤₛₜ may be service no 145: Operator controlled signal threshold per access technology. This service may be a way for a network node to indicate to an IoT UE that the operator controlled signal threshold per access technology is available.

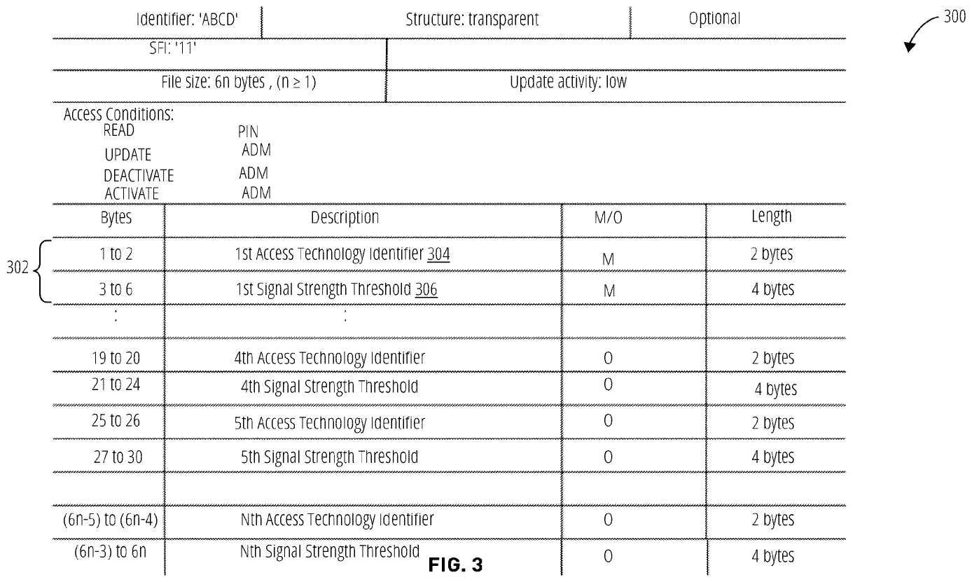

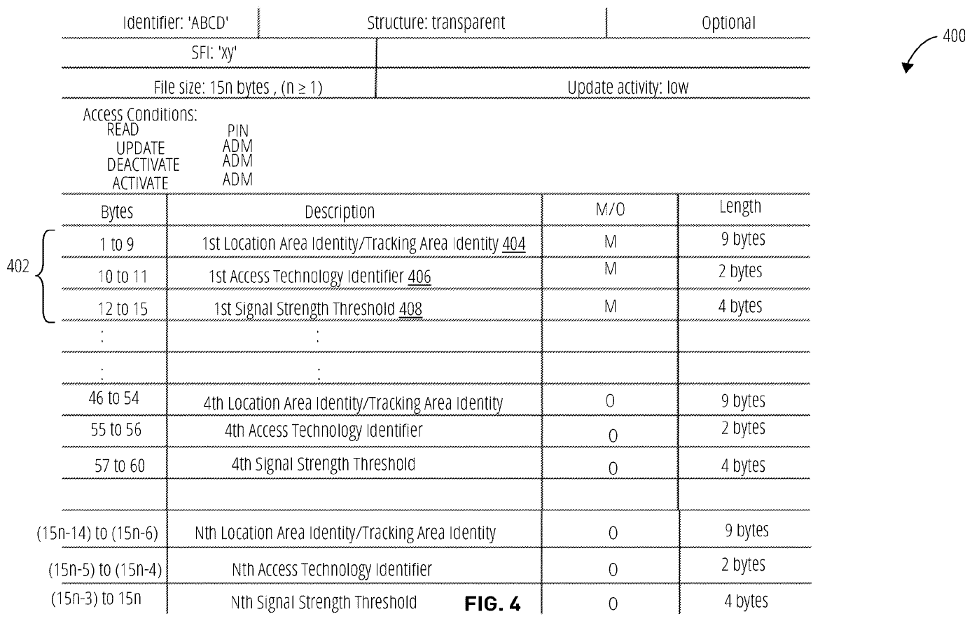

Another USIM update may include an additional EF for the operator controlled signal threshold per access technology (EF_{OCSIGHRESHACT}). For example, FIG. 3 and FIG. 4 illustrate possible EF_{OCSIGHRESHACT} structures.

Specifically, FIG. 3 illustrates an EF_{OCSIGHRESHACT} 300 that indicates an access technology and an associated operator controlled signal threshold in accordance with some embodiments. In some embodiments, if service no 145 is “available”, this file (i.e., EF_{OCSIGHRESHACT} 300) shall be present.

EF_{OCSIGHRESHACT} 300 includes coding for a number (n) of Access Technologies where n is determined by the operator. For example, the first record 302 indicates the first Access Technologies using a first Access Technology Identifier 304, and the associated operator controlled signal threshold for that access technology using the first Signal Strength Threshold 306.

The Access Technology Identifiers and Signal Strength Thresholds may be fields within the EF_{OCSIGHRESHACT} 300 that may be configured by the operator. These fields may provide the IoT UE with information that may be used during network selection. For instance, the EF_{OCSIGHRESHACT} 400 may be used when attempting to register a PLMN using the method 100 of FIG. 1 or the method 200 of FIG. 2

The Access Technology Identifiers may be two bytes that indicate the access technology. For example, the Access Technology Identifiers may be coded according to EF for the User controlled PLMN selector with Access Technology (EF_{PLMNwACT}). The signal strength threshold may be four bytes that indicate the operator controlled signal threshold for the associated access technology.

FIG. 4 illustrates an EF_{OCSIGHRESHACT} 400 that indicates a location, an access technology, and an associated operator controlled signal threshold in accordance with some embodiments. In some embodiments, if service no 145 is “available”, this file (i.e., EF_{OCSIGHRESHACT} 400) shall be present.

EF_{OCSIGHRESHACT} 400 includes coding for a number of Location Area Code/Tracking Area Code (LAC/TAC), Access Technologies and the associated operator controlled signal threshold for that access technology. For example, the first record 402 indicates a first LAC/TAC (e.g., 1st Location Area Identity/Tracking Area Identity 404), a first Access Technologies (e.g., 1st Access Technology Identifier 406), and an associated operator controlled signal threshold for that access technology at that LAC/TAC (e.g., 1st Signal Strength Threshold 408).

The location area identity/tracking area identity, Access Technology Identifiers, and Signal Strength Thresholds may be fields within the EF_{OCSIGHRESHACT} 300 that may be configured by the operator. These fields may provide the IoT UE with information that may be used during network selection. For instance, the EF_{OCSIGHRESHACT} 400 may be used when attempting to register a PLMN using the method 100 of FIG. 1 or the method 200 of FIG. 2

The location area identity/tracking area identity may be nine bytes that include information regarding the area associated with the signal strength threshold. The location area identity may comprise a MCC (Mobile Country Code), MNC (Mobile Network Code), and LAC. The tracking area identity may comprise MCC, MNC, and TAC. Coding of the location area identity/tracking area identity may be done according other aspects of the standard. For example, PLMN may be according to TS 24.501/24.008/24.301. A ‘BCD’ value of ‘D’ in any of the MCC and/or MNC digits may be used to indicate a “wild” value for that corresponding MCC/MNC digit. The TAC may be coded according to TS.24.501 for NG-RAN, else LAC/TAC according to 24.008/24.301. Two values for TAC/LAC may be stored in order to allow a range of TAC/LAC values for a specified PLMN, where the Access Technology Identifier, and Signal Strength Threshold shall be applicable. If TAC/LAC uses only 2 bytes, then unused bytes may be set as FF.

A value of ‘000000’ stored in bytes 4 to 6 and a value of ‘FFFFFE’ may be used to indicate the entire range of TACs for a given PLMN, when TAC is 3 bytes. A value of ‘FF0000’ stored in bytes 4 to 6 and a value of ‘FFFFFE’ may be used to indicate the entire range of TACs/LACs for a given PLMN when TAC is 2 bytes. If Bytes 4 to 6 is identical to values stored in bytes 7 to 9 for a given PLMN, it may indicate the specific TAC for this PLMN where this Access Technology Identifier, and Signal Strength Threshold shall be applicable. (Byte 4, and Byte 7 shall be set as FF if 2 byte TAC/LAC is only used). In order to represent a range of TAC values, then the value stored in bytes 4 to 6 shall be start of TAC range and the value stored in bytes 7 to 9 shall be end of TAC range for the given PLMN. Byte 4, and Byte 7 may be set as FF if 2 byte TAC/LAC is only used.

The Access Technology Identifiers may be two bytes that indicate the access technology. For example, the Access Technology Identifiers may be coded according to EF for the User controlled PLMN selector with Access Technology (EF_{PLMNwACT}). The signal strength threshold may be four bytes that indicate the operator controlled signal threshold for the associated access technology.

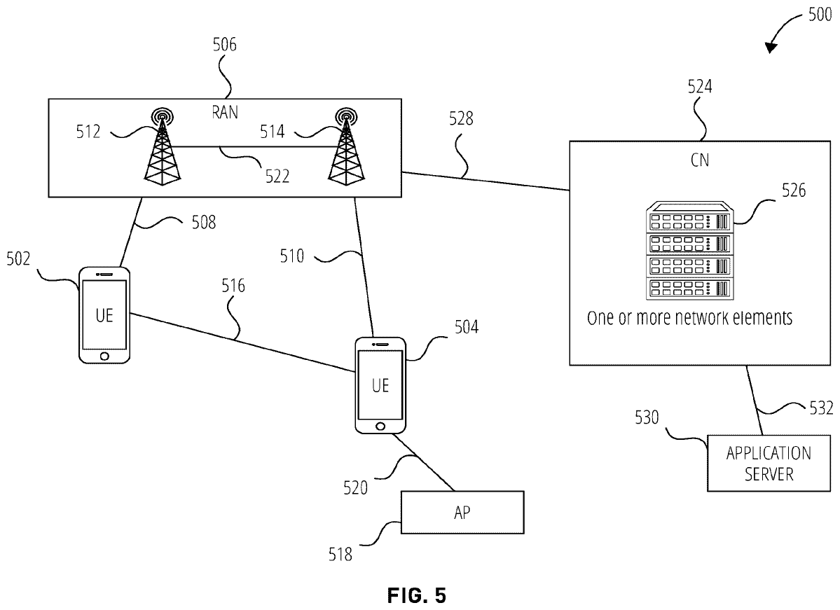

FIG. 5 illustrates an example architecture of a wireless communication system 500, according to embodiments disclosed herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, etc. The UE 502 and UE 504 utilize connections (or channels) (shown as connection 508 and connection 510, respectively) with the RAN 506, each of which comprises a physical communications interface. The RAN 506 can include one or more base stations (such as base station 512 and base station 514) that enable the connection 508 and connection 510.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more base stations (e.g., two or more gNBs and the like) that connect to 5GC, between a base station 512 (e.g., a gNB) connecting to 5GC and an eNB, and/or between two eNBs connecting to 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an S1 interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VOIP sessions, group communication sessions, etc.) for the UE 502 and UE 504 via the CN 524. The application server 530 may communicate with the CN 524 through an IP communications interface 532.

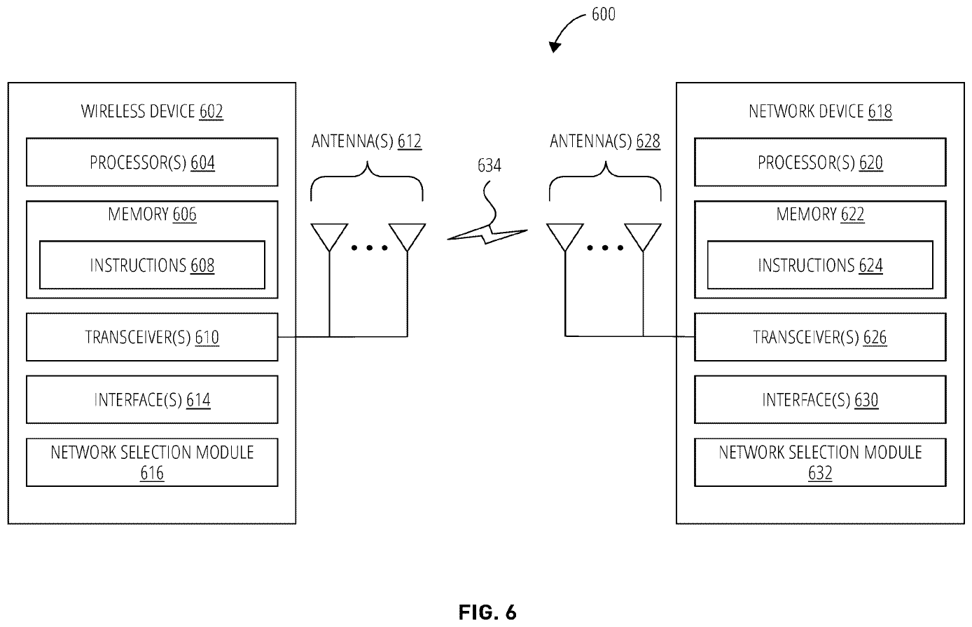

FIG. 6 illustrates a system 600 for performing signaling 634 between a wireless device 602 and a network device 618, according to embodiments disclosed herein. The system 600 may be a portion of a wireless communications system as herein described. The wireless device 602 may be, for example, a UE of a wireless communication system. The network device 618 may be, for example, a base station (e.g., an eNB or a gNB) of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter and/or receiver circuitry that use the antenna(s) 612 of the wireless device 602 to facilitate signaling (e.g., the signaling 634) to and/or from the wireless device 602 with other devices (e.g., the network device 618) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include a network selection module 616. The network selection module 616 may be implemented via hardware, software, or combinations thereof. For example, the network selection module 616 may be implemented as a processor, circuit, and/or instructions 608 stored in the memory 606 and executed by the processor(s) 604. In some examples, the network selection module 616 may be integrated within the processor(s) 604 and/or the transceiver(s) 610. For example, the network selection module 616 may be implemented by a combination of software components (e.g., executed by a DSP or a general processor) and hardware components (e.g., logic gates and circuitry) within the processor(s) 604 or the transceiver(s) 610.

The network selection module 616 may be used for various aspects of the present disclosure, for example, aspects of FIGS. 1-4. The network selection module 616 is configured to perform a PLMN selection with an operator controlled signal strength threshold.

The network device 618 may include one or more processor(s) 620. The processor(s) 620 may execute instructions such that various operations of the network device 618 are performed, as described herein. The processor(s) 620 may include one or more baseband processors implemented using, for example, a CPU, a DSP, an ASIC, a controller, an FPGA device, another hardware device, a firmware device, or any combination thereof configured to perform the operations described herein.

The network device 618 may include a memory 622. The memory 622 may be a non-transitory computer-readable storage medium that stores instructions 624 (which may include, for example, the instructions being executed by the processor(s) 620). The instructions 624 may also be referred to as program code or a computer program. The memory 622 may also store data used by, and results computed by, the processor(s) 620.

The network device 618 may include one or more transceiver(s) 626 that may include RF transmitter and/or receiver circuitry that use the antenna(s) 628 of the network device 618 to facilitate signaling (e.g., the signaling 634) to and/or from the network device 618 with other devices (e.g., the wireless device 602) according to corresponding RATs.

The network device 618 may include one or more antenna(s) 628 (e.g., one, two, four, or more). In embodiments having multiple antenna(s) 628, the network device 618 may perform MIMO, digital beamforming, analog beamforming, beam steering, etc., as has been described.

The network device 618 may include one or more interface(s) 630. The interface(s) 630 may be used to provide input to or output from the network device 618. For example, a network device 618 that is a base station may include interface(s) 630 made up of transmitters, receivers, and other circuitry (e.g., other than the transceiver(s) 626/antenna(s) 628 already described) that enables the base station to communicate with other equipment in a core network, and/or that enables the base station to communicate with external networks, computers, databases, and the like for purposes of operations, administration, and maintenance of the base station or other equipment operably connected thereto.

The network device 618 may include a network selection module 632. The network selection module 632 may be implemented via hardware, software, or combinations thereof. For example, the network selection module 632 may be implemented as a processor, circuit, and/or instructions 624 stored in the memory 622 and executed by the processor(s) 620. In some examples, the network selection module 632 may be integrated within the processor(s) 620 and/or the transceiver(s) 626. For example, the network selection module 632 may be implemented by a combination of software components (e.g., executed by a DSP or a general processor) and hardware components (e.g., logic gates and circuitry) within the processor(s) 620 or the transceiver(s) 626.

The network selection module 632 may be used for various aspects of the present disclosure, for example, aspects of FIGS. 1-4. The network selection module 632 is configured to support a UE selecting a PLMN.

Embodiments contemplated herein include an apparatus comprising means to perform one or more elements of the method 100 of FIG. 1 and method 200 of FIG. 2. This apparatus may be, for example, an apparatus of a UE (such as a wireless device 602 that is a UE, as described herein).

Embodiments contemplated herein include one or more non-transitory computer-readable media comprising instructions to cause an electronic device, upon execution of the instructions by one or more processors of the electronic device, to perform one or more elements of the method 100 of FIG. 1 and method 200 of FIG. 2. This non-transitory computer-readable media may be, for example, a memory of a UE (such as a memory 606 of a wireless device 602 that is a UE, as described herein).

Embodiments contemplated herein include an apparatus comprising logic, modules, or circuitry to perform one or more elements of the method 100 of FIG. 1 and method 200 of FIG. 2. This apparatus may be, for example, an apparatus of a UE (such as a wireless device 602 that is a UE, as described herein).

Embodiments contemplated herein include an apparatus comprising: one or more processors and one or more computer-readable media comprising instructions that, when executed by the one or more processors, cause the one or more processors to perform one or more elements of the method 100 of FIG. 1 and method 200 of FIG. 2. This apparatus may be, for example, an apparatus of a UE (such as a wireless device 602 that is a UE, as described herein).

Embodiments contemplated herein include a signal as described in or related to one or more elements of the method 100 of FIG. 1 and method 200 of FIG. 2.

Embodiments contemplated herein include a computer program or computer program product comprising instructions, wherein execution of the program by a processor is to cause the processor to carry out one or more elements of the method 100 of FIG. 1 and method 200 of FIG. 2. The processor may be a processor of a UE (such as a processor(s) 604 of a wireless device 602 that is a UE, as described herein). These instructions may be, for example, located in the processor and/or on a memory of the UE (such as a memory 606 of a wireless device 602 that is a UE, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), the method comprising:
determining if a signal threshold file is available on a Universal Subscriber Identity Module (USIM), wherein the signal threshold file includes an operator controlled signal threshold;
performing a signal threshold based public land mobile network (PLMN) selection procedure using the operator controlled signal threshold when the signal threshold file is available;
performing a non-signal threshold based public land mobile network (PLMN) selection procedure when the signal threshold file is not available; and
registering with a PLMN for communication.

2. The method of claim 1, further comprising performing the non-signal threshold based PLMN selection when no suitable PLMN is found using the signal threshold based PLMN selection.

3. The method of claim 1, wherein the operator controlled signal threshold is configured per access technology.

4. The method of claim 1, wherein the operator controlled signal threshold is configured based on location.

5. The method of claim 1, wherein the signal threshold file comprises an elementary file with records comprising corresponding location area identities and tracking area identities, access technology identifiers, and signal strength thresholds.

6. The method of claim 1, further comprising comparing a received signal quality in a cell of a candidate PLMN to the operator controlled signal threshold.

7. The method of claim 6, wherein if the operator controlled signal threshold is available, the UE shall select a network if network selection conditions are met and the received signal quality in a cell of the candidate PLMN is equal to or higher than the operator controlled signal threshold.

8. A non-transitory computer-readable storage medium, the computer-readable storage medium including instructions that when executed by a user equipment (UE), cause the UE to:
determine if a signal threshold file is available on a Universal Subscriber Identity Module (USIM), wherein the signal threshold file includes an operator controlled signal threshold;
perform a signal threshold based public land mobile network (PLMN) selection procedure using the operator controlled signal threshold when the signal threshold file is available;
perform a non-signal threshold based public land mobile network (PLMN) selection procedure when the signal threshold file is not available; and
register with a PLMN for communication.

9. The computer-readable storage medium of claim 8, wherein the instructions further configure the UE to perform the non-signal threshold based PLMN selection when no suitable PLMN is found using the signal threshold based PLMN selection.

10. The computer-readable storage medium of claim 8, wherein the operator controlled signal threshold is configured per access technology.

11. The computer-readable storage medium of claim 8, wherein the operator controlled signal threshold is configured based on location.

12. The computer-readable storage medium of claim 8, wherein the signal threshold file comprises an elementary file with records comprising corresponding location area identities and tracking area identities, access technology identifiers, and signal strength thresholds.

13. The computer-readable storage medium of claim 8, wherein the instructions further configure the UE to compare a received signal quality in a cell of a candidate PLMN to the operator controlled signal threshold.

14. The computer-readable storage medium of claim 13, wherein if the operator controlled signal threshold is available, the UE shall select a network if network selection conditions are met and the received signal quality in a cell of the candidate PLMN is equal to or higher than the operator controlled signal threshold.

15. A user equipment (UE) comprising:
a processor; and
a memory storing instructions that, when executed by the processor, configure the UE to:
determine if a signal threshold file is available on a Universal Subscriber Identity Module (USIM), wherein the signal threshold file includes an operator controlled signal threshold;
perform a signal threshold based public land mobile network (PLMN) selection procedure using the operator controlled signal threshold when the signal threshold file is available;
perform a non-signal threshold based public land mobile network (PLMN) selection procedure when the signal threshold file is not available; and
register with a PLMN for communication.

16. The UE of claim 15, wherein the instructions further configure the UE to perform the non-signal threshold based PLMN selection when no suitable PLMN is found using the signal threshold based PLMN selection.

17. The UE of claim 15, wherein the instructions further configure the UE to compare a received signal quality of a candidate PLMN to the operator controlled signal threshold.

18. The UE of claim 17, wherein if the operator controlled signal threshold is available, the UE shall select a network only if the network selection conditions are met and the received signal quality of the candidate PLMN is equal to or higher than the operator controlled signal threshold.

19. The UE of claim 15, wherein the signal threshold file comprises an elementary file with records comprising corresponding location area identities and track area identities, access technology identifiers, and signal strength thresholds.

20. The UE of claim 15, wherein the UE is a stationary IoT device.

21-22. (canceled)
